(19) United States
(12) Patent Application Publication
(10) Pub. No.: US 2012/0197584 A1
(43) Pub. Date: Aug. 2, 2012

(54) Core Temperature Monitoring

(75) Inventor: Keven Dale Coates, Cypress, TX (US)

(73) Assignee: TEXAS INSTRUMENTS INCORPORATED, Dallas, TX (US)

(21) Appl. No.: 13/018,317

(22) Filed: Jan. 31, 2011

(51) Int. Cl. G06F 19/00

(52) U.S. Cl. 702/131

(57) ABSTRACT

A system and method for providing continuous core temperature measurements through the use of non-movement inhibiting devices is disclosed. A user may wear a core temperature measuring device that constantly monitors and analyzes the user's core temperature measurements to identify any concerning trends. The monitoring may be done locally or through a base station. When a concerning trend is detected, the user and/or interested third parties may be alerted so that action can be taken to reverse the trend.

### TECHNICAL FIELD

Embodiments of the invention are directed, in general, to providing health monitoring services, more specifically, to methods and systems for providing monitoring of core temperature measurements.

### BACKGROUND

The human body works best at its ideal core temperature. When that temperature goes up or down even slightly, a number of problems, such as an increased risk of illness, can result. Usually, body temperature is monitored only when suspected medical problems are indicated, such as by physical signs of fever, skin tone, etc. However, this type of sporadic temperature monitoring does not distinguish between normal daily variations of a person's core temperature, which can typically vary as much as one degree Fahrenheit, and irregular core temperatures that may indicate illness.

For example, when a person goes into a cold environment, that person's core temperature would initially be unaffected, but after a long enough period, that person's core temperature would fall. A sporadic temperature measurement taken even after the core temperature has fallen would not indicate sickness even though the body has been weakened. Such weakening of a person's body leads to increases in the risk of illness. This can be prevented simply by warming up the person's body. However, a person is typically unaware of this trend, either because the person is focused on the task at hand or otherwise not concerned. Children and the elderly in particular would benefit from an alert indicating an alarming change in core temperature.

### SUMMARY

By taking continuous measurements at a regular range, a baseline pattern for an individual's body temperature can be established and used to aid in identifying unhealthy variances, even when the temperature is within what would be considered a normally acceptable range. Such changes may be identified instantly is continuous monitoring is used. Embodiments of the invention are directed to providing continuous core temperature measurements with the use of non-movement prohibiting instruments. When a user initiates a core temperature measuring device, the core temperature measuring device registers itself with a base station by transmitting its device number. Using the device number, the base station identifies the user associated with the core temperature measuring device and transmits that user's baseline information to the registering core temperature measuring device. Upon receiving the baseline information, the core temperature measuring device stores the data locally.

The core temperature measuring device collects core temperature measurements from the user and stores these measurements locally. Each time a new measurement is made, the core temperature measuring device uses the local analysis engine to analyze the new measurement against the baseline data. If a concerning trend is detected, the core temperature measuring device notifies the user. At predetermined intervals, the core temperature measuring device transmits these measurements to the base station. Alternatively, the core temperature measuring device may transmit data to the base station after each new measurement is made.

Once the base station receives the data transmitted by the core temperature measuring device, the base station stores and analyzes the data. If the analysis detects an alarming trend, the base station may notify the user and/or interested third parties. The notification may include audio and/or visual cues. However, if no alarming trend is detected, the base station stores the analysis information.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram of an exemplary core temperature measuring system;

FIG. 2 is a block diagram of an exemplary embodiment of the core temperature measuring device; and

FIG. 3 is a flow diagram illustrating use of a core temperature measuring system according to one embodiment.

### DETAILED DESCRIPTION

The invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

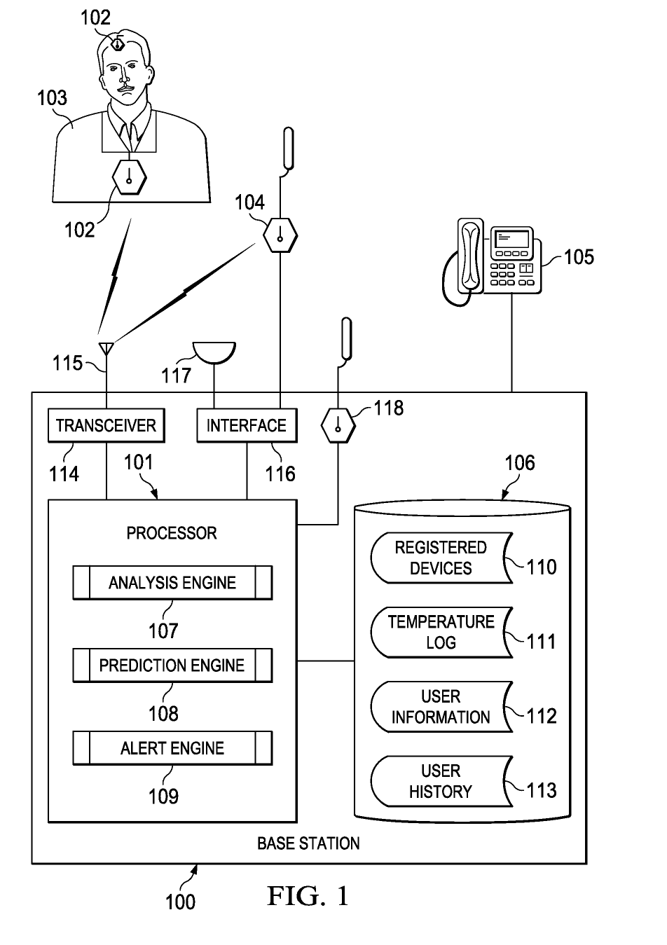

FIG. 1 is a block diagram of an exemplary embodiment of a core temperature measuring system in which a base station 100 communicates with a core temperature measuring device 102 and an alert system 105. One or more core temperature measuring devices 102 and/or alert systems 105 may be supported by base station 100. Base station 100 may communicate with core temperature measuring device 102 and alert system 105 via any wireless or wireline communication network, such as packet-based network including the Internet, local area network (LAN), metropolitan area network (MAN), wide area network (WAN), WiFi (IEEE 802.11), Unlicensed Mobile Access (UMA), WiMax (IEEE 802.16), 802.14, satellite transmission system, or any other communications network.

Base station 100 is a processor-driven device or devices configured to receive and process core temperature measurements as well as alert potentially the user or potentially interested third parties of any alarming changes in temperature. Base station 100 includes processor 101 that processes and analyzes core temperature measurements and provides the services described herein. Base station 100 stores data and software programs or modules that are used by processor 101 in memory 106, which may be logically or physically divided. The data and program modules include, for example, analysis engine 107, prediction engine 108 and alert engine 109. Additionally, base station 100 may also comprise or be in communication with one or more databases, memories, or data storage devices. For example, base station 100 communicates with or comprises registered device database 110, temperature log database 111, user information database 112, and user history database 113.

Base station 100 may communicate with core temperature measuring device 102 or other devices via wireless communications methods and protocols using transceiver 114. Wireless communications are transmitted to and received from other devices using antenna 115, which may be an internal, external, or surface mount antenna. Alternatively, base station 100 may communicate over a direct or wireline connection to the core temperature measuring device 102 or other device via interface 211. Connector 117 provides a connection to a network, wire or cable or may be a plug or socket that allows for direct connection to device 102.

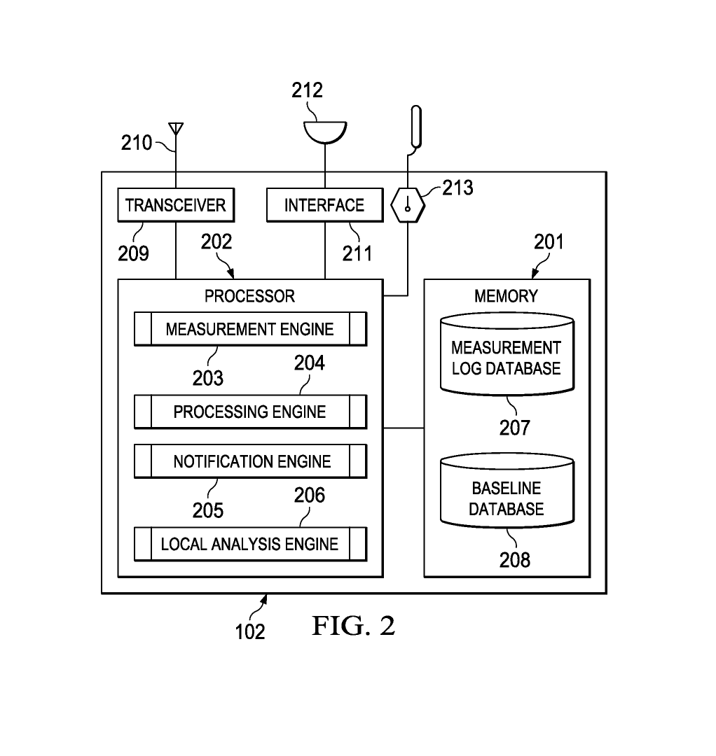

In one embodiment, core temperature measuring device 102 is a processor-driven device configured to measure and process core temperature measurements. FIG. 2 is a block diagram of an exemplary embodiment of the core temperature measuring device. To process core temperature measurements, and provide the services described herein, core temperature measuring device 102 stores data and software programs and modules in a memory 201 that may be logically or physically divided. The data and program modules run on a processor 202. The data and program modules include, for example, a measurement engine 203, processing engine 204, notification engine 205 and local analysis engine 206. Additionally, core temperature measuring device 102 also comprises one or more databases including, for example, a measurement log database 207 and a baseline database 208.

Core temperature measuring device 102 may communicate with a base station or other devices via wireless communications methods and protocols using transceiver 209. Wireless communications are transmitted to and received from other devices using antenna 210, which may be an internal, external, or surface mount antenna. Alternatively, device 102 may communicate over a direct or wireline connection to the base station or other device via interface 211. Connector 212 provides a connection to a network, wire or cable or may be a plug or socket that allows for direct connection to another device, such as base station 100 via connector 117. Temperature sensor 213 monitors, measures, and/or detects the user's temperature. Temperature sensor 213 may use any technology now known or later developed, including, without limitation, thermometers using infrared radiation, resistance, thermochromic liquid crystals, phosphor thermometry, or silicon bandgap sensors to measure the user's core temperature.

Temperature sensor 213 may measure the user's core temperature by direct contact with the user or by remote sensing. Core temperature measuring device 102 may be embodied as any small, non-movement inhibiting wearable device that enables skin contact with the user 103. For example, core temperature measuring device 102 may be a stand-alone device, such as a wristband, anklet, earring, and/or the like, or an integrated device, such as a sensor embedded into existing articles of clothing, such as a headband, shirt, hat, etc., of the user 103. In certain embodiments, the integrated device may be interchangeable between the existing articles of clothing. In one embodiment, the user 103 may have and use more than one core temperature measuring device 102. However, only one core temperature measuring device 102 may be used by the user 103 at any given time. The user 103 may indicate which core temperature measuring device 102 is in use by turning off all other core temperature measuring devices 102 owned by the user 103. Alternatively, the base station 100 may determine which core temperature measuring device 102 is in use, for example, by identifying which device 102 is sensing a temperature that is close to normal human body temperature. In other embodiments, the core temperature measuring device may also include a display that shows a current or last core temperature reading, an average core temperature, and/or alerts the user of any deviances.

The core temperature measuring system may include an outside temperature measuring device 104. This device 104 may be a processor-driven device configured to measure and process outside temperature measurements and is similar to the core temperature measuring device except that it measures outside temperature instead of core temperature. Measurements made by the outside temperature measuring device 104 may be also sent wirelessly or by a direct connection to the base station 100, where the measurements are stored in the temperature log 111. Outside temperature measuring device 104 may be placed in any place that the user 103 frequents. Although the word “outside” is used herein, the outside temperature measuring device 104 will be understood to include any area where temperature can be measured, including areas inside a structure. Further, one or more outside temperature measuring devices 104 are supported by the base station 100. The user may indicate which outside temperature measuring device 104 is active by turning off all other outside temperature measuring devices 104 used by the user 103. Alternatively, the base station 100 can determine which outside temperature measuring device 104 is in use. In some embodiments, the outside temperature measuring device is not associated with just one user 103, and the base station 100 may determine if a user 103 is in close proximity to an outside temperature measuring device 104. If so, the base station 100 will use the outside temperature reading as part of its analysis.

In other embodiments, base station 100 may include an internal temperature sensor 118 in addition to, or instead of, external temperature measuring device 104. Internal temperature sensor 118 monitors, measures, and/or detects the outside or environmental temperature. Temperature sensor 118 and temperature measuring device 104 may use any technology now known or later developed, including, without limitation, thermometers using infrared radiation, resistance, thermochromic liquid crystals, phosphor thermometry, or silicon bandgap sensors to measure the user's core temperature.

Alert system 105 is a telecommunications system configured to communicate wirelessly with the base station 100. When the base station 100 notifies the alert system 105 of an alarming trend, the alert system warns interested third parties including, for example, a physician listed by the user 103, emergency personnel, or another interested third party on behalf of the user 103. The alert system 105 may issue warnings using any means of communication including, for example, telephone call (wired or wireless), pager message, email message, text message, and/or the like. The warnings may be prerecorded or preselected messages, such as prerecorded voice messages that are transmitted using a telephone call, or prepared text that is transmitted in email messages. A plurality of voice or text messages may be stored in memory 106, for example, and processor 101 may select an appropriate message to be broadcast based upon current conditions measured using sensor 102.

In one embodiment, the user 103 initiates a core temperature reading by turning on the core temperature measuring device 102. Once the core temperature measuring device 102 is initiated, it attempts to either communicate with the base station 100 or takes a core temperature measurement. If the core temperature measuring device 102 is unable to communicate with the base station 100, it will take the core temperature measurement of the user 103.

Core temperature measuring device 102 uses measurement engine 203 to obtain a core temperature reading from the user 103. The core temperature reading is then stored in measurement log database 207. Measurement log database 207 stores all core temperature readings that occur between communication sessions with the base station 100. For example, the core temperature measuring device 102 is set to communicate with the base station every hour, but it is programmed to take core temperature readings every five minutes. Each measurement taken during the hour would be stored in the measurement log database 207 along with the time at which the measurement was made. To ensure that the communication delay between the core temperature measuring device 102 and the base station 100 does not miss the detection of a concerning trend, the local analysis engine 206 would use the baseline statistics in the baseline database 208 to perform an analysis on the measurement readings store in the measurement log database 207.

Core temperature measuring device 102 uses processing engine 204 to prepare the data in the measurement log database 207 and transfers it to the base station 100. In preparing the data, the processing engine 204 adds the device identification information to the information in the measurement log database 207. After the data is prepared, the processing engine 204 sends it in packets to the base station 100.

Base station 100 stores the data sent by the processing engine 204 into the temperature log database 111. Using the information in the temperature log database 111, the analysis engine 107 performs an analysis on all measurement readings associated with the user 103. This analysis is compared to the baseline information in the user history database 113. If there is a concerning trend in the data, the alert engine 109 sends a message to the alert system 105 and the core temperature measuring device 102 to notify them of the trend. In some embodiments, the prediction engine 108 may use the information in the user history database 113 and the information outputted by the analysis engine to predict of a concerning trend is forming. However, if there is no concerning trend indicated, the base station 100 stores the new baseline information in the user history database 113 and sends the same data to the core temperature measuring device 102, which stores the data in the baseline database 208. After the new baseline data is store, the measurement log database 207 is cleared so that only the measurements taken during the next communication delay is stored in there.

Core temperature measuring device 102 uses notification engine 205 to alert the user 103 if there is an alarming trend in core temperature deviations. When an alarming trend is detected, the notification engine 205 warns the user through the use of visual or audio cues including, for example, beeping, vibrating, flashing, and/or the like.

In another embodiment, the user 103 initiates a core temperature reading by turning on the core temperature measuring device 102. There is no base station 100 to communicate with. Instead, all functions are handled by the core temperature measuring device 102. Therefore, when the core temperature measuring device is initiated, a core temperature measurement is taken by the measurement engine 111. That measurement is stored in the measurement log database 207. Each time a new measurement is detected, the local analysis engine 206 performs statistical analysis based on the new measurement and the data in the measurement log database 207 and baseline database 208. If there a concerning trend is detected, the notification engine 205 warns the user in a similar manner as described above.

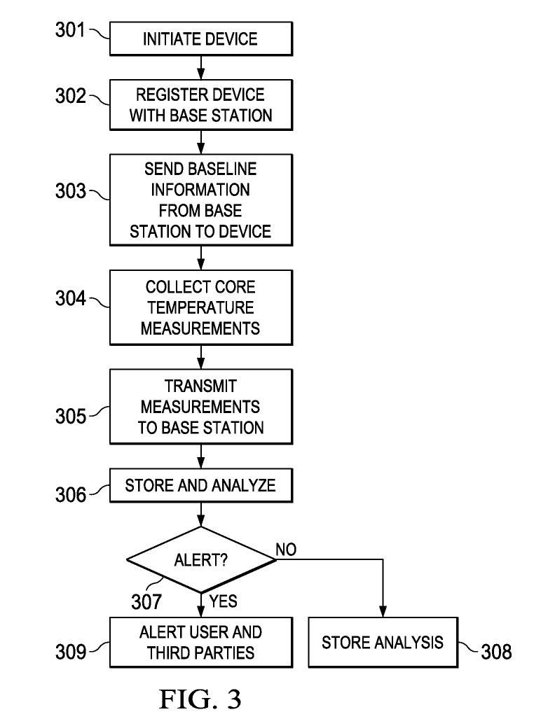

FIG. 3 is a flow diagram illustrating use of a core temperature measuring system according to one embodiment. At step 301, the user initiates the core temperature measuring device. Next, at step 302, the core temperature measuring device registers with the base station. When registering with the base station, the core temperature measuring device transmits its device number. Upon receiving the device number, the base station updates the device status in the registered devices database 110.

In step 303, the base station sends the core temperature measuring device the baseline data for the user of the registered device. To identify the user, the base station checks the registered devices database 110. After determining the user's identity, the system locates the user's baseline data in the user history database 113. The baseline data is then sent to the core temperature measurement device and stored in the baseline data 208.

In step 304, the core temperature measuring device collects core temperature measurements. The core temperature measuring device, in some embodiments, is programmed to transmit data to the base station in set intervals. In such cases, the core temperature reading is stored in the measurement log database 207 and then analyzed by the local analysis engine 206. Part of the analysis would be based on the information in the baseline database 208. Alternatively, the core temperature measuring device transmits data to the base station each time it makes a new temperature measurement.

In step 305, the core temperature measuring device transmits the measure data to the base station. Then in step 306, the base station stores the transmitted data into the temperature log database 111 and uses the analysis engine 107 to identify any concerning trends. Based on the results provided by the analysis engine 107, the system determines at step 307 whether to alert the user and/or interested third parties.

If a concerning trend is not identified by the analysis engine 107, the process continues to step 308. In step 308, the system stores the analysis information in the user history database 113 and revises the user's baseline information in the user information database 112 if necessary.

If a concerning trend is identified by the analysis engine 107, the process continues to step 309. In step 309, the base station uses the alert engine to notify the user and third parties, such as physician listed by the user, emergency personnel, and/or another interested third party. To notify the user, the base station sends a message to the core temperature measuring device. The core temperature measuring device alerts the user using the notification engine to create visual and/or audio signals, such as beeping, vibrating, flashing, and/or the like. Similarly, the system notifies interested third parties by sending a message to the alarm system. After receiving the message from the base station, the alarm system notifies the interested third parties through any means of communication, such as phone call (wired or wireless), email, text message, and/or the like.

One of the advantages of the invention is that it can be worn by users participating in activities occurring in extreme weather conditions or in weather that is not the user's normal environment. For example, a user may wear the device when skiing. Often, a skier is too focused on traversing the slopes to notice changes in his body temperature or, in some cases, simply chooses to ignore the changes. If the user is not used to cold weather or to wearing extra clothing, then the user may not recognize changes in his or her body temperature. In cases where the skier is unaware of body temperature changes, the invention would recognize an alarming trend and notify the skier of the trend. Once the skier is notified, the skier may take action to reverse the trend, such as putting on additional layers of clothing or returning to the lodge for a break. Similarly, a user who is temporarily in a tropical climate may not recognize changes in their body temperature or may misidentify such changes as weather-related. A body temperature monitoring system, such as device 102 and the system described herein, would help the user to identify

Many modifications and other embodiments of the invention will come to mind to one skilled in the art to which this invention pertains having the benefit of the teachings presented in the foregoing descriptions, and the associated drawings. Therefore, it is to be understood that the invention is not to be limited to the specific embodiments disclosed. Although specific terms are employed herein, they are used in a generic and descriptive sense only and not for purposes of limitation.

What is claimed is:

1. A system for measuring core temperature, comprising:
a core temperature measuring device, wherein the core temperature measuring device maintains skin contact with a user;
a base station adapted to analyze core body temperature measurements over time; and
a temperature database for storing core body temperature data.

2. The claim of system 1 wherein the core temperature measuring device includes an external display.

3. The claim of system 1, further comprising an alert system configured to communicate with said base station.

4. The claim of system 1, further comprising an outside temperature measuring device.

5. The claim of system 1 wherein the core temperature measuring device is adapted to analyze core body temperature measurements stored in a local measurement log database.

6. A system for measuring core temperature, comprising:
a core temperature measuring device, wherein the core temperature measuring device does not require skin contact with a user;
a base station adapted to analyze core body temperature measurements over time; and
a temperature log database for storing core body temperature data.

7. The claim of system 6 wherein the core temperature measuring device includes an external display.

8. The claim of system 6, further comprising an alert system configured to communicate with said base station.

9. The claim of system 6, further comprising an outside temperature measuring device.

10. The claim of system 6 wherein the core temperature measuring device is adapted to analyze core body temperature measurements stored in a local measurement log database.

11. A method for measuring core temperature, comprising:
initiating a core temperature measuring device;
registering the core temperature measuring device with a base station;
transmitting core temperature measurements from the core temperature measuring device to the base station;
storing the core temperature measurements into a temperature log database; and
analyzing said core temperature measurements by an analysis engine.

12. The method of claim 11 further comprising:
sending baseline information from the base station to the core temperature measuring device.

13. The method of claim 11 further comprising:
collecting core temperature measurements by said core temperature measurement device; and
storing said core temperature measurements into a local measurement log database.

14. The method of claim 11 further comprising:
identifying a concerning temperature trend by said analysis engine; and
notifying the user and interested third parties of the concerning temperature trend.
